(19) United States
(12) Patent Application Publication
(10) Pub. No.: US 2012/0020775 A1
(43) Pub. Date: Jan. 26, 2012

(54) FLOW SPLITTER ASSEMBLY FOR STEAM TURBOMACHINE AND METHOD

(75) Inventors: Prashant Prabhakar Sankolli, Bangalore (IN); Laurence Scott Duclos, Unity, ME (US); Maurice David Fournier, Hermon, ME (US)

(73) Assignee: GENERAL ELECTRIC COMPANY, Schenectady, NY (US)

(21) Appl. No.: 12/840,795

(22) Filed: Jul. 21, 2010

(51) Int. Cl. F01D 17/00; B23P 19/00

(52) U.S. Cl. 415/145; 29/700

(57) ABSTRACT

A turbomachine includes a first turbine portion and a second turbine portion. A flow splitter assembly is coupled between the first and second turbine portions. The flow splitter assembly includes a first end portion including a first mounting member and a second end portion including a second mounting member. A flow diverting member is positioned between the first and second end portions. The flow diverting member includes a first end section having a first mounting element coupled to the first mounting member and a second end section having a second mounting element coupled to the second mounting member. The flow diverting member includes a flow diverting surface. A first locking member engages the first mounting element and the first mounting member, and a second locking member engages the second mounting element and the second mounting member.

### BACKGROUND OF THE INVENTION

The subject matter disclosed herein relates to the art of turbomachines and, more particularly to a flow splitter assembly for a steam turbomachine.

In a steam turbomachine, high pressure, high temperature steam is utilized as a working fluid. Inlet steam is passed through a nozzle toward a plurality of buckets. The nozzle conditions the inlet steam which then flows onto the buckets. The buckets rotate thereby transforming thermal energy from the steam to mechanical, rotational, energy that drives a shaft. The shaft is employed to drive a component such as a generator or a pump. In a double flow steam turbomachine, inlet steam is split for flow into axially opposed turbomachine units each including associated nozzles and buckets for driving corresponding machinery. The flow is split using a tub or flow splitter having an inlet and two axially opposed outlets.

Conventional flow splitters are massive structures that are both costly and heavy. A typical flow splitter is formed by joining two mirror image axial halves. The axial halves are bolted together with large bolts passing through flanges to form a bolt circle along an inside radial surface of the flow splitter. Typically, each axial half is machined from a large forging. Machining the large forging results in a significant waste of machined stock. After machining, the axial halves are bolted together and joined to the steam turbomachine.

### BRIEF DESCRIPTION OF THE INVENTION

According to one aspect of the invention, a turbomachine includes a first turbine portion having a first inlet section and a second turbine portion having a second inlet section. A flow splitter assembly is coupled between the first and second inlet sections of the first and second turbine portions. The flow splitter assembly includes a first end portion mounted to the first inlet section. The first end portion includes a first mounting member. A second end portion is mounted to the second inlet section and includes a second mounting member. A flow diverting member is positioned between the first and second end portions. The flow diverting member includes a first end section having a first mounting element operatively coupled to the first mounting member and a second end section having a second mounting element operatively coupled to the second mounting member. The flow diverting member includes a flow diverting surface that guides a fluid flow toward each of the first and second inlet sections. A first locking member engages the first mounting element and the first mounting member, and a second locking member engages the second mounting element and the second mounting member. The first and second locking members join the flow diverting member to the first and second end portions.

According to another aspect of the invention, a method of joining a flow splitter to a turbomachine includes positioning a flow splitter assembly between first and second turbine portions of a double steam turbine with the flow splitter assembly including a first end portion and a second end portion, mounting a flow diverting member between the first end portion and the second end portion, engaging a first mounting member provided on the first end portion of the flow splitter assembly with a first mounting element provided on a first end section of the flow diverting member, connecting a second mounting member provided on the second end portion of the flow splitter assembly with a second mounting element provided on a second end section of the flow diverting member, and interlocking the first mounting member with the first mounting element and the second mounting member with the second mounting element.

According to yet another aspect of the invention, a flow splitter assembly includes a first end portion having a first mounting member, a second end portion having a second mounting member, and a flow diverting member positioned between the first and second end portions. The flow diverting member includes a first end section having a first mounting element operatively coupled to the first mounting member and a second end section having a second mounting element operatively coupled to the second mounting member. The flow diverting member includes a flow diverting surface. A first locking member engages the first mounting element and the first mounting member and a second locking member engages the second mounting element and the second mounting member. The first and second locking members join the flow diverting member to the first and second end portions.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a turbomachine including a flow splitter assembly in accordance with an exemplary embodiment;

FIG. 2 is a lower left perspective view of the flow splitter assembly in accordance with an exemplary embodiment;

FIG. 3 is a cross-sectional view of the flow splitter assembly of FIG. 2;

FIG. 4 is a partial perspective cross-sectional view of the flow splitter assembly of FIG. 2;

FIG. 5 is a detailed view of a portion of the flow splitter assembly of FIG. 4;

FIG. 6 is a cross-sectional view of a flow splitter assembly in accordance with another exemplary embodiment;

FIG. 7 is a cross-sectional view of a flow splitter assembly in accordance with still another exemplary embodiment; and

FIG. 8 is a cross-sectional view of a flow splitter assembly in accordance with yet another exemplary embodiment.

The detailed description explains embodiments of the invention, together with advantages and features, by way of example with reference to the drawings.

### DETAILED DESCRIPTION OF THE INVENTION

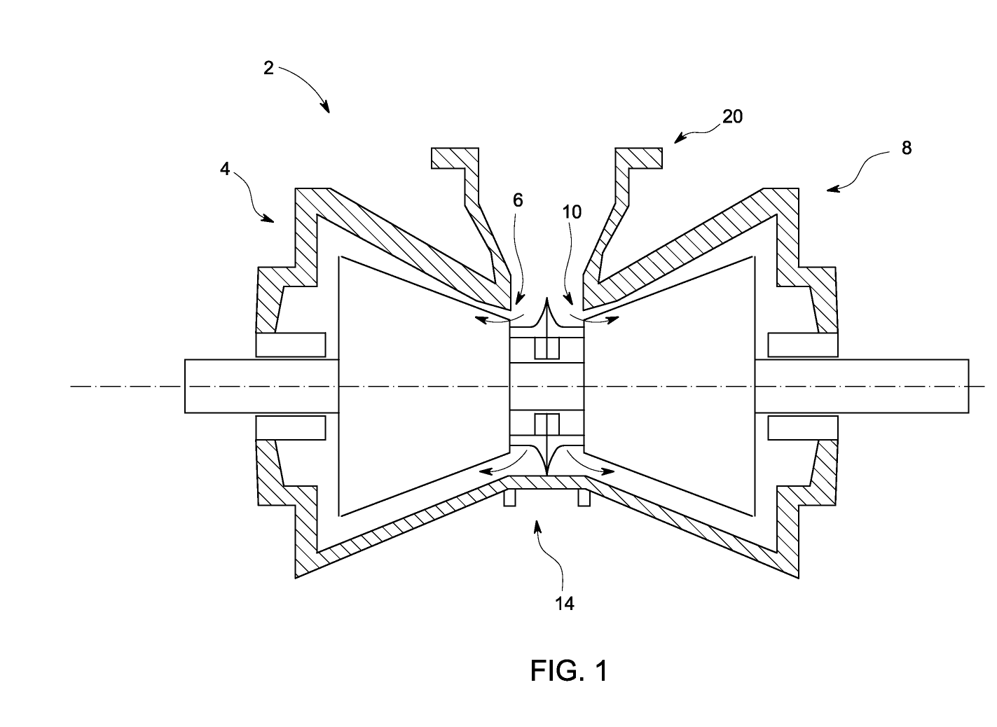

A turbomachine in accordance with an exemplary embodiment is indicated generally at 2 in FIG. 1. Turbomachine 2 takes the form of a double flow steam turbine including a first turbine portion 4 having a first inlet section 6 and a second turbine portion 8 having a second inlet section 10. A flow splitter assembly 14 joins first and second turbine portions 4 and 8. As will be discussed more fully below, flow splitter assembly 14 guides a fluid flow through an inlet 20 to respective ones of first and second inlet sections 6 and 10.

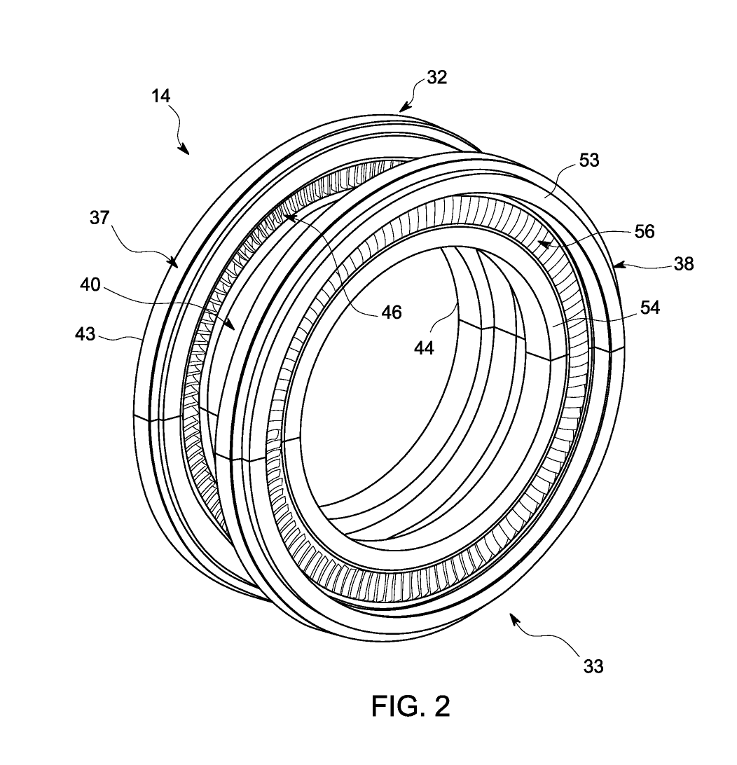

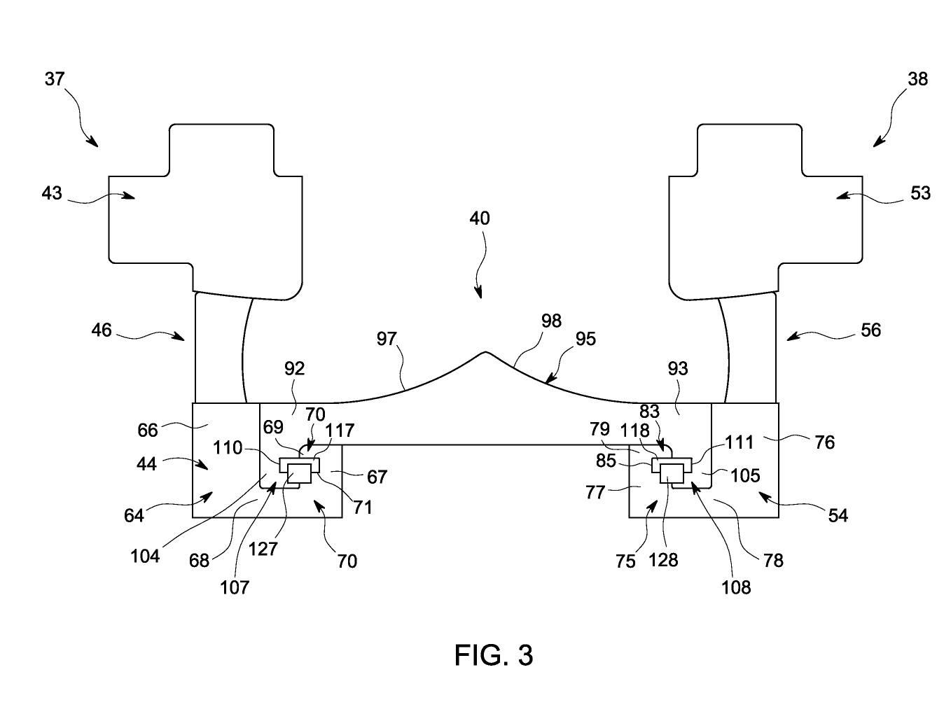

As best shown in FIGS. 2-5, flow splitter assembly 14 includes a first half 32 that is joined to a second half 33 to form an annular ring. As each half 32, 33 is substantially identically formed, a detailed description will follow with reference to first half 32 with an understanding that second half 33 includes similar structure. First half 32 of flow splitter assembly 14 includes a first end portion 37 joined to a second end portion 38 through a flow diverting member 40. First end portion 37 includes a first outer ring 43 operatively coupled to a first inner ring or web 44 through a first plurality of nozzles 46. First plurality of nozzles 46 condition a fluid flow passing into first inlet section 6. Similarly, second end portion 38 includes a second outer ring 53 operatively coupled to a second inner ring or web 54 through a second plurality of nozzles 56. Second plurality of nozzles 56 condition a fluid flow passing into second inlet section 10.

In accordance with an exemplary embodiment, first inner ring 44 includes a first mounting member 64 configured to engage with flow diverting member 40. First mounting member 64 includes a first section 66 that is joined to a second section 67 through a third section 68. First mounting member 64 is also shown to include a fourth section 69 that creates a hook member 70, and a slot member 71. Slot member 71 is defined between third section 68 and fourth section 69. Similarly, second inner ring 54 includes a second mounting member 75 having a first section 76 that is joined to a second section 77 through a third section 78. Second mounting member 75 is also shown to include a fourth section 79 that defines, at least in part, a hook member 83 and a slot member 85. That is, slot member 85 is defined between third section 78 and fourth section 79.

In further accordance with the exemplary embodiment, flow diverting member 40 includes a first end section 92 that extends to a second end section 93 through a flow diverting surface 95. Flow diverting surface 95 includes a first sloping zone 97 and a second opposing sloping zone 98. First sloping surface 97 guides fluid toward first inlet section 6 and second sloping zone 98 guides fluid toward second inlet section 10. Flow diverting member 40 includes a first mounting element 104 arranged at first end section 92 and a second mounting element 105 arranged at second end section 93. First mounting element 104 includes a first hook element 107 and second mounting element 105 includes a second hook element 108. First mounting element 104 also includes a first slot element 110 and second mounting element 105 includes a second slot element 111.

With this arrangement, flow diverting member 40 is mounted between first and second end portions 37 and 38. More specifically, first mounting element 104 is operatively connected to first mounting member 64. Once engaged, first slot element 110 registers with first slot member 71. Likewise, second mounting element 105 is operatively connected to second mounting member 75. Once engaged, second slot element 111 registers with second slot member 85. At this point, a first locking member, which takes the form of a radial strip 117, is inserted between first mounting member 64 and first mounting element 104. More specifically, radial strip 117 is slidingly engaged into first slot member 71 and first slot element 110. Similarly, a second locking member or radial strip 118 is inserted between second mounting member 75 and second mounting element 105. More specifically, second locking radial strip 118 is slidingly engaged into second slot member 85 and second slot element 111.

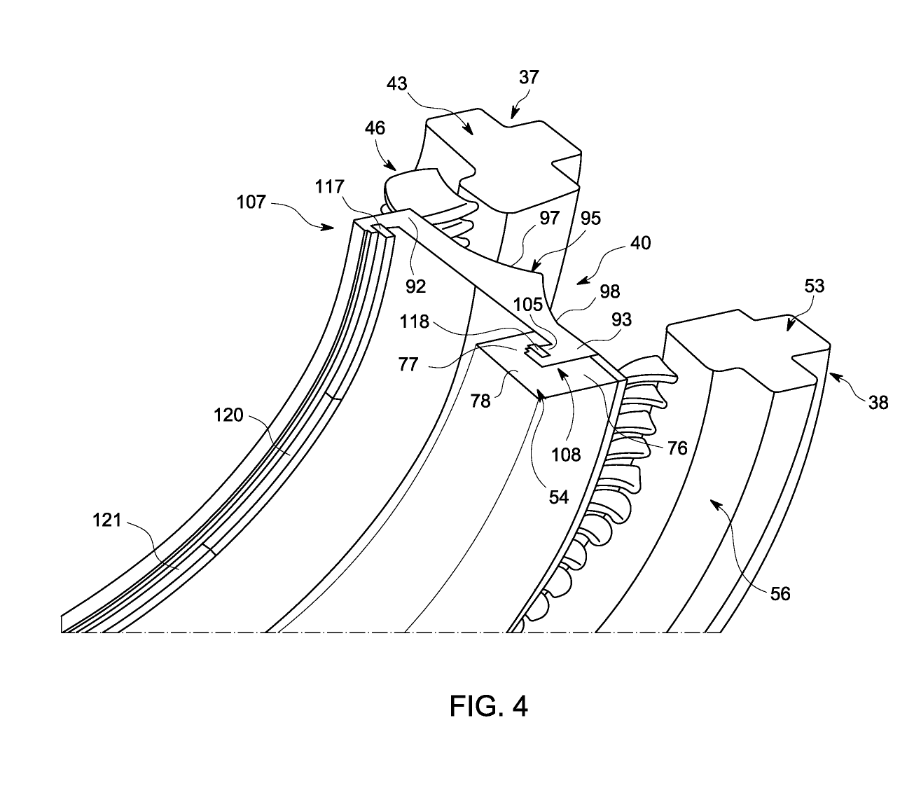

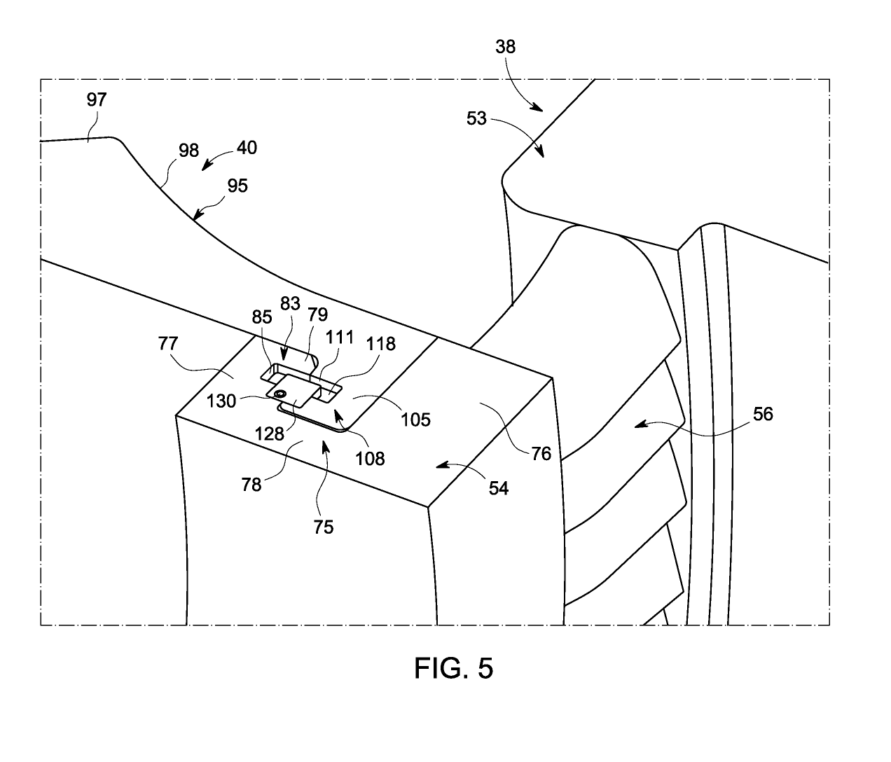

In accordance with one aspect of the exemplary embodiment, in addition to first radial strip 117 additional radial strips, two of which are shown at 120 and 121 in FIG. 4, are inserted between first mounting member 64 and first mounting element 104. Similar additional radial strips (not shown) are also employed between second mounting member 75 and second mounting element 105. The use of multiple radial strips enables easy insertion between first mounting member 64 and first mounting element 104. In this manner, flow diverting member 40 is locked into engagement with first and second end portions 37 and 38. In order to secure first and second radial strips 117 and 118, flow splitter assembly 14 includes a first retention element 127 that secures first locking member 117 to first inner ring 44 and a second retention element 128 that secures second locking member 118 to second inner ring 54. First and second retention elements 127 and 128 are held in place by corresponding first and second screws, one of which is shown at 130 in FIG. 5.

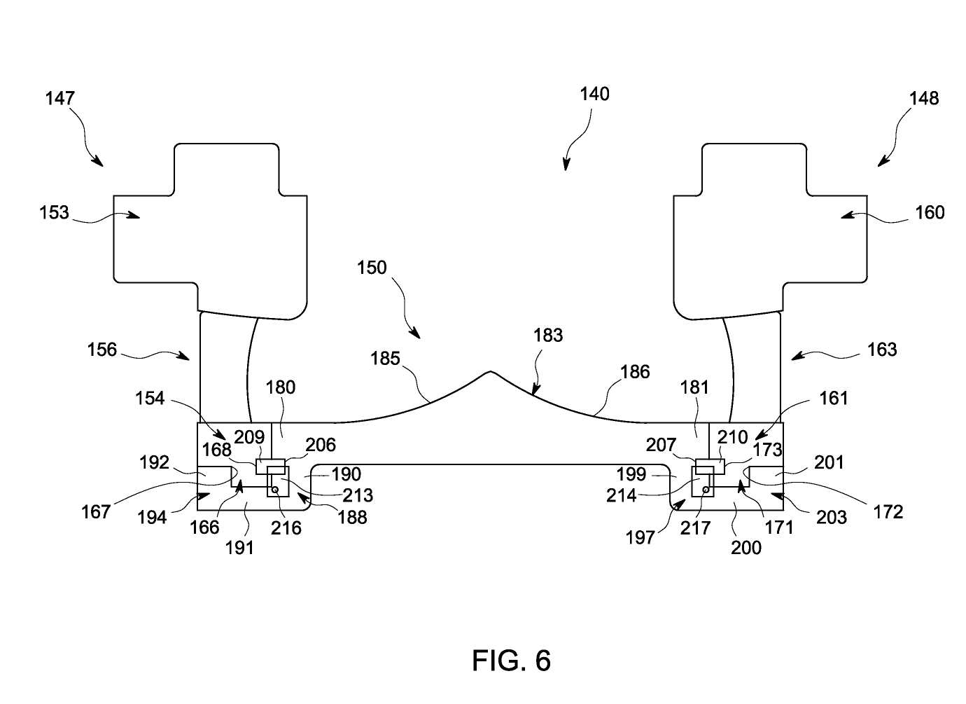

Reference will now be made to FIG. 6 in describing a flow splitter assembly 140 in accordance with another exemplary embodiment. Flow splitter assembly 140 includes a first end portion 147 joined to a second end portion 148 through a flow diverting member 150. First end portion 147 includes a first outer ring 153 operatively coupled to a first inner ring or web 154 through a first plurality of nozzles 156. Nozzles 156 condition a fluid flow passing into first inlet section 6. Similarly, second end portion 148 includes a second outer ring 160 operatively coupled to a second inner ring or web 161 through a second plurality of nozzles 163. Second plurality of nozzles 163 condition a fluid flow passing into second inlet section 10.

In accordance with an exemplary embodiment, first inner ring 154 includes a first mounting member 166 having a first hook member 167 and a first slot member 168. Similarly, second inner ring 161 includes a second mounting member 171 having a second hook member 172 and a second slot member 173. As will be discussed more fully below, first and second mounting members 166 and 171 are configured to engage with flow diverting member 150.

In further accordance with the exemplary embodiment, flow diverting member 150 includes a first end section 180 that leads to a second end section 181 through a flow diverting surface 183. Flow diverting surface 183 includes a first sloping zone 185 and a second sloping zone 186. First sloping zone 185 guides fluid towards first inlet section 6 while second sloping zone 186 guides fluid toward second inlet section 10. Flow diverting member 150 also includes a first mounting element 188 arranged at first end section 180. First mounting element 188 includes a first section 190 that leads to a second section 191 and a third section 192 thereby defining a first hook element 194. Flow diverting member 150 also includes a second mounting element 197 arranged at second end section 181. Second mounting element 197 includes a first section 199 that leads to a second section 200 and a third section 201 thereby defining a second hook element 203. First mounting element 188 includes a first slot element 206 and second mounting element 197 includes a second slot element 207.

With this arrangement, flow diverting member 150 is mounted between first and second end portions 147 and 148. More specifically, first hook element 194 is operatively connected to first hook member 167. Once engaged, first slot element 206 registers with first slot member 168. Likewise, second hook element 203 is operatively connected to second hook member 172. Once engaged, second slot element 207 registers with second slot member 173. At this point, a first locking member or radial strip 209 is inserted between first mounting member 166 and first mounting element 188. More specifically, first radial strip 209 is slidingly engaged into first slot member 168 and first slot element 206. Similarly, a second locking member or radial strip 210 is inserted between second mounting member 171 and second mounting element 197. More specifically, second radial strip 210 is slidingly engaged into second slot member 173 and second slot element 207. In a manner similar to that described above, first and second radial strips 209 and 210 are secured by corresponding first and second retaining members 213 and 214. First and second retaining members 213 and 214 are themselves secured by corresponding first and second screws 216 and 217.

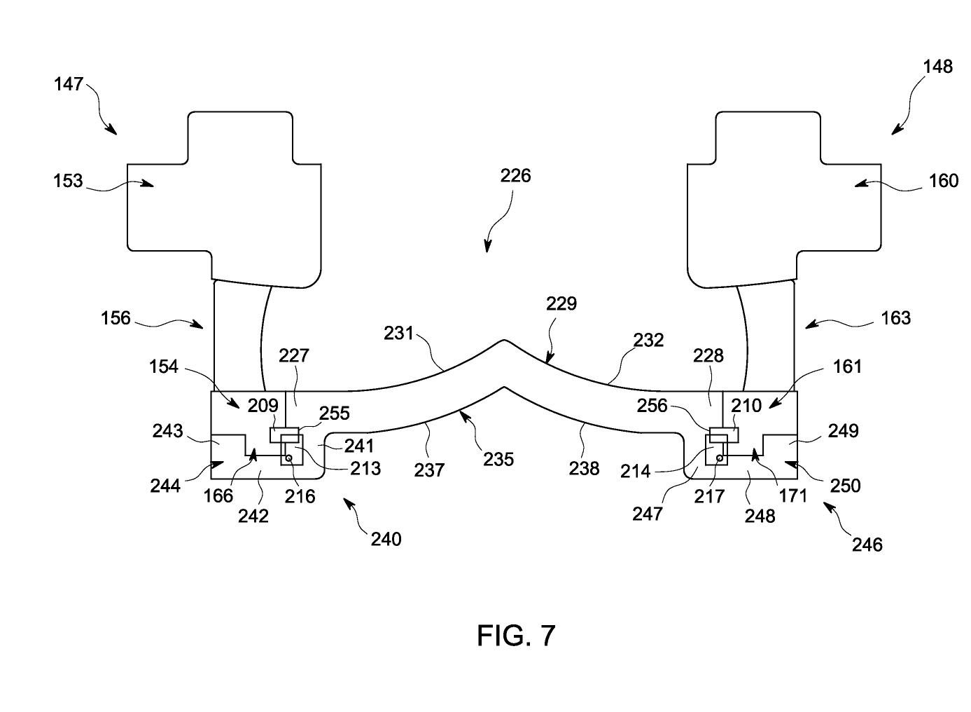

Reference will now be made to FIG. 7, wherein like reference numbers represent corresponding parts in the respective views, in describing a flow diverting member 226 in accordance with another exemplary embodiment. Flow diverting member 226 includes a first end section 227 that extends to a second end section 228 through a flow diverting surface 229. Flow diverting surface 229 includes a first sloping zone 231 and a second sloping zone 232. First sloping zone 231 guides fluid toward first inlet section 6 and second sloping zone 232 guides fluid toward second inlet section 10. Flow diverting member 226 is further shown to include an outer surface 235. Outer surface 235 includes a third sloping zone 237 and a fourth sloping zone 238. Third and fourth sloping zones 237 and 238 represent a removal of material from flow diverting member 226 that results in lower material costs, and lower weight. The lower material costs and weight produces various manufacturing efficiencies.

In a manner similar to that described above, flow diverting member 226 includes a first mounting element 240 arranged at first end section 227. First mounting element 240 includes a first section 241 that leads to a second section 242 and a third section 243 thereby defining a first hook element 244. Flow diverting member 226 also includes a second mounting element 246 arranged at second end section 228. Second mounting element 246 includes a first section 247 that leads to a second section 248 and a third section 249 thereby defining a second hook element 250. First mounting element 240 includes a first slot element 255 and second mounting element 246 includes a second slot element 256. First and second mounting elements 240 and 246 are configured to cooperate with first and second mounting members 166 and 171 to join flow diverting member 226 to first and second end portions 147 and 148.

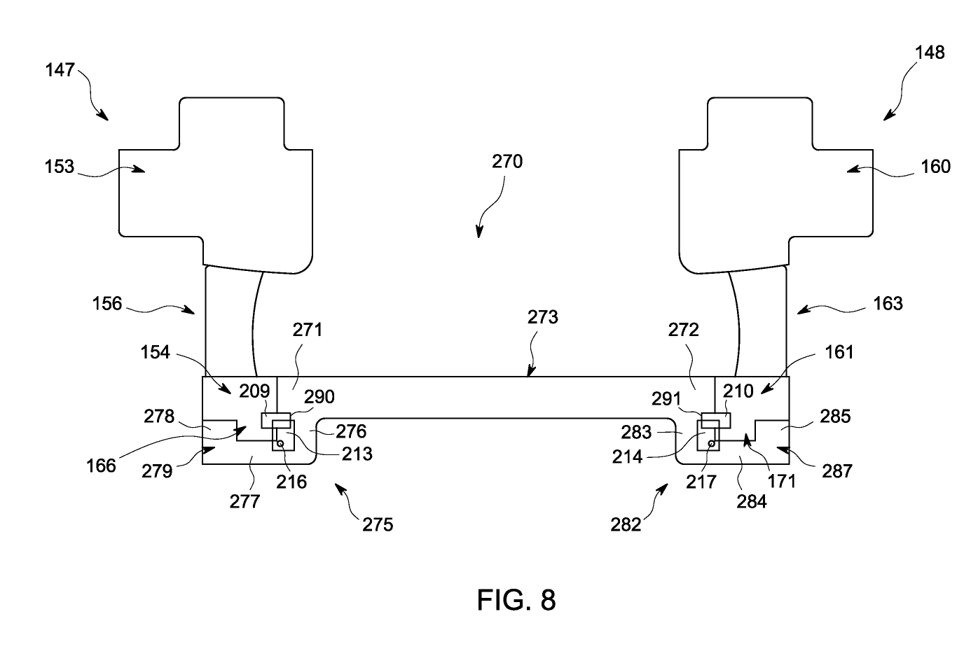

Reference will now be made to FIG. 8, wherein like reference numbers represent corresponding parts in the respective views, in describing a flow diverting member 270 in accordance with another exemplary embodiment. Flow diverting member 270 includes a first end section 271 that extends to a second end section 272 through a flow diverting surface 273. In accordance with the exemplary embodiment shown, flow diverting surface 273 is a substantially planar surface that does not include any flow directing features. The lack of flow diverting features results in lower weight for flow diverting member 270. The lower weight provides various efficiency enhancements to turbomachine 2.

In a manner similar to that described above, flow diverting member 270 includes a first mounting element 275 arranged at first end section 271. First mounting element 275 includes a first section 276 that leads to a second section 277 and a third section 278 thereby defining a first hook element 279. Flow diverting member 270 also includes a second mounting element 282 arranged at second end section 272. Second mounting element 282 includes a first section 283 that leads to a second section 284 and a third section 285 thereby defining a second hook element 287. First mounting element 275 includes a first slot element 290 and second mounting element 282 includes a second slot element 291. First and second mounting elements 275 and 282 are configured to cooperate with first and second mounting members 166 and 171 to join flow diverting member 270 to first and second end portions 147 and 148.

At this point it should be understood that the exemplary embodiments provide a flow splitter assembly for a dual flow turbine turbomachine that is readily assembled without the need for multiple mechanical fasteners such as bolts and nuts. The removal of the multiple mechanical fasteners reduces cost and machining operations for the flow splitter assembly. Furthermore, by eliminating joints from a central region of the flow diverting member, frictional losses on surfaces of the flow splitter resulting from leakage steam are reduced. The reduction in leakage steam enhances turbine efficiency. In addition, the exemplary embodiments simplify construction techniques bey facilitating the use of Metal Inert Gas (MIG) welds as well as the use of forgings, instead of machining operations to form the various components. The use of forgings leads to s significant savings by reducing waste associated with machining operations. Finally, the exemplary embodiments enable each component to be formed separately thereby reducing overall production lead time for the flow splitter assembly.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a first turbine portion including a first inlet section;
a second turbine portion positioned adjacent the first turbine portion, the second turbine portion including a second inlet section; and
a flow splitter assembly coupled between the first and second inlet sections of the first and second turbine portions, the flow splitter assembly including:
a first end portion mounted to the first inlet section, the first end portion including a first mounting member;
a second end portion mounted to the second inlet section, the second end portion including a second mounting member;
a flow diverting member positioned between the first and second end portions, the flow diverting member including a first end section including a first mounting element operatively coupled to the first mounting member, and a second end section including a second mounting element operatively coupled to the second mounting member, the flow diverting member including a flow diverting surface that guides an airflow toward each of the first and second inlet sections; and
a first locking member engaging the first mounting element and the first mounting member and a second locking member engaging the second mounting element and the second mounting member, the first and second locking members joining the flow diverting member to the first and second end portions.

2. The turbomachine according to claim 1, further comprising:
a first retention element engaged to the first locking member; and
a second retention element engaged to the second locking member.

3. The turbomachine according to claim 2, wherein the first locking member comprises at least one radial strip slidingly engaged with the first mounting element and the first mounting member.

4. The turbomachine according to claim 3, wherein the at least one radial strip includes a plurality of radial strips slidingly engaged between the first mounting element and the first mounting member.

5. The turbomachine according to claim 1, wherein the first mounting element includes a hook element and the first mounting member includes a hook member, the hook element being configured and disposed to interlock with the hook member to join the flow diverting member with the first end portion.

6. The turbomachine according to claim 5, wherein the hook element includes a slot element and the hook member includes a slot member, the slot element registering with the slot member when the hook element interlocks with the hook member.

7. The turbomachine according to claim 6, wherein the first locking member extends into the slot element and the slot member to secure the flow diverting member to the first end portion.

8. The turbomachine according to claim 1, wherein the first end portion includes an inner ring joined to an outer ring through a plurality of nozzles, the first mounting member being provided on the inner ring.

9. The turbomachine according to claim 1, wherein the flow splitter assembly is devoid of mechanical fasteners joining the flow diverting member with the first end portion and the second end portion.

10. The turbomachine according to claim 1, wherein the flow splitter assembly includes a first half joined to a second half to form an annular ring.

11. The turbomachine according to claim 1, wherein the flow diverting surface includes a first sloping zone that is configured and disposed to guide an airflow toward the first inlet section and a second sloping zone that is configured and disposed to guide an airflow toward the second inlet section.

12. The turbomachine according to claim 11, wherein the flow diverting member includes a third sloping zone and a fourth sloping zone arranged on a surface opposite to the flow diverting surface.

13. The turbomachine according to claim 1, wherein the flow diverting surface comprises a substantially planar surface.

14. A method of joining a flow splitter assembly to a turbomachine, the method comprising:
positioning a flow splitter assembly between first and second turbine portions of a double steam turbine, the flow splitter assembly including a first end portion and a second end portion;
mounting a flow diverting member between the first end portion and the second end portion;
engaging a first mounting member provided on the first end portion of the flow splitter assembly with a first mounting element provided on a first end section of the flow diverting member;
connecting a second mounting member provided on the second end portion of the flow splitter assembly with a second mounting element provided on a second end section of the flow diverting member; and
interlocking the first mounting member with the first mounting element and the second mounting member with the second mounting element.

15. The method of claim 14, further comprising: locking the first mounting member to the first mounting element and the second mounting member and the second mounting element.

16. The method of claim 15, wherein locking the first mounting member to the first mounting element includes inserting a lock member between the first mounting element and the first mounting member.

17. The method of claim 16, wherein engaging the first mounting member with the first mounting element includes inter-connecting a first hook member and a first hook element, the first hook member including a first slot member and the first hook element including a first slot element.

18. The method of claim 17, wherein inserting the lock member includes sliding a retention strip into first slot member and the first slot section.

19. The method of claim 18, further comprising: retaining the retention strip relative to the first mounting member and the first mounting element.

20. A flow splitter assembly comprising:
a first end portion including a first mounting member;
a second end portion including a second mounting member;
a flow diverting member positioned between the first and second end portions, the flow diverting member including a first end section including a first mounting element operatively coupled to the first mounting member and a second end section including a second mounting element operatively coupled to the second mounting member, the flow diverting member including a flow diverting surface; and
a first locking member engaging the first mounting element and the first mounting member and a second locking member engaging the second mounting element and the second mounting member, the first and second locking members joining the flow diverting member to the first and second end portions.
